(19) United States
(12) Patent Application Publication
(10) Pub. No.: US 2007/0070021 A1
(43) Pub. Date: Mar. 29, 2007

(54) Display apparatus

(75) Inventors: Byeong-Jae Ahin, Seoul (KR); Beom-Jun Kim, Seoul (KR); Sung-Man Kim, Seoul (KR); Bong-Jun Lee, Seoul (KR); Hyeong-Jun Park, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/528,214

(22) Filed: Sep. 26, 2006

(30) Foreign Application Priority Data
Sep. 26, 2005 (KR) 2005-89359

(51) Int. Cl. G09G 3/36

(52) U.S. Cl. 345/100

(57) ABSTRACT

A scan driver sequentially activates scan lines of a display apparatus having m-number of scan lines. The scan driver includes a pull-up driving section and a pull-down driving section. The pull-up driving section includes a pull-up transistor that is electrically connected to an ith scan line to activate the ith scan line to be in a high level state. The pull-down driving section includes a pull-down transistor that is electrically connected to the ith scan line to inactivate the ith scan line to be in a low level state when (i+1)th scan line is activated. A gate electrode of the pull-up transistor is electrically separated from the ith scan line. The above ‘m’ is an integer greater than 1, and ‘i’ is an integer no greater than ‘m’. Therefore, display defects may be minimized, and detecting a cause of the display defect may be simplified to enhance productivity.

### CROSS-REFERENCE TO RELATED APPLICATIONS

This application relies for priority upon Korean Patent Application No. 2005-89359 filed on Sep. 26, 2005, the contents of which are herein incorporated by reference in its entirety.

### FIELD OF THE INVENTION

The present invention relates to a shift register, a scan driver and a display apparatus having the scan driver.

### DESCRIPTION OF THE RELATED ART

Display apparatus, such as liquid crystal displays (LCD), organic light-emitting displays (OLED), plasma display panel (PDP), etc., convert electric signal processed by an information processing apparatus into an image. The display apparatus includes a display panel and a driving section that drives the display panel. The display panel includes a plurality of scan lines extending along a first direction and data lines extending along a second direction that is substantially perpendicular to the first direction.

The driving section includes a shift register sequentially activating the scan lines of the display panel. When the scan lines are activated by the shift register, data voltages are applied to the data lines corresponding to the activated scan lines to cause the display panel to display an image.

FIG. 1 is an equivalent circuit diagram illustrating a stage of a conventional shift register, and FIG. 2 is a front-view of a display panel driven by the conventional shift register when a breakdown occurs in one of the stages of the conventional shift register. When a breakdown occurs at a region ‘A’ in FIG. 1, the display defect occurs as shown in FIG. 2.

However, when the gate electrode of a transistor (not shown but schematically illustrated by the series of un-numbered resistors connected to OS[N]) driving a pixel is shorted to the common voltage, the defective display does not occur as shown in FIG. 2. In particular, when the gate electrode of the transistor is electrically shorted to the common voltage or when the gate electrode is electrically shorted to the drain electrode exhibiting a data voltage, the common voltage or the data voltage is applied to the gate electrode of pull-up transistor TFT1 and the gate electrode of carrier transistor TFT15. Therefore, pull-up transistor TFT1 and carrier transistor TFT 15 do not operate normally.

Furthermore, as shown in FIG. 2, when a display defect occurs during the test process for manufacturing a display panel, the cause of that defect cannot be definitely determined as either a breakdown at the display panel or at the driving part. Therefore, much time is required to ascertain the cause, thereby lowering productivity.

### SUMMARY OF THE INVENTION

The present invention provides a shift register capable of minimizing a display defect and, if a defect occurs, detecting the cause of the display defect, thereby enhancing productivity. The present invention also provides a scan driver capable of activating scan lines next to a scan line associated with a short circuited transistor. In an exemplary embodiment, the shift register according to the present invention, includes an nth stage and an (n+1)th stage. The nth stage outputs an nth output signal. The (n+1)th stage is electrically connected to the nth stage. The (n+1)th stage outputs an (n+1)th output signal that is normal even when the nth output signal is abnormal, where ‘n’ represents a natural number.

For example, the nth stage and the (n+1)th stage respectively include a pull-up driving section and a pull-down driving section. The pull-up driving section includes a pull-up transistor that is electrically connected to an output terminal that outputs both the nth output signal and the (n+1)th output signal to the high level state. The pull-down driving section includes a pull-down transistor that is electrically connected to the output terminal. The pull-down transistor lowers the nth output signal and the (n+1)th output signal to the low level state. The gate electrode of the pull-up transistor is electrically separated from the output terminal.

In an exemplary scan driver according to the present invention, the scan driver sequentially activates scan lines of a display apparatus having m-number of scan lines extended along a first direction, n data lines extended along a second direction that is different from the first direction, and switching transistors. Each of the switching transistors is formed in a pixel region defined by two adjacent scan lines and two adjacent data lines. The scan driver includes a pull-up driving section and a pull-down driving section. The pull-up driving section includes a pull-up transistor that is electrically connected to an ith scan line to activate the ith scan line to be in a high level state. The pull-down driving section includes a pull-down transistor that is electrically connected to the ith scan line to inactivate the ith scan line causing it to be in a low level state when (i+1)th scan line is activated. The gate electrode of the pull-up transistor is electrically separated from the ith scan line. The above ‘m’ and ‘n’ are integers greater than 1 and ‘i’ is an integer no greater than ‘m’.

In an exemplary display apparatus according to the present invention, the display apparatus includes a display panel and a driving part. The display panel includes m scan lines extended along a first direction, n data lines extended along a second direction that is different from the first direction, and switching transistors. Each of the switching transistors is formed in a pixel region defined by two adjacent scan lines and two adjacent data lines. The driving part drives the display panel. The driving part includes a pull-up driving section and a pull-down driving section. The pull-up driving section includes a pull-up transistor that is electrically connected to an ith scan line to activate the ith scan line to be in a high level state. The pull-down driving section includes a pull-down transistor that is electrically connected to the ith scan line to inactivate the ith scan line to be in a low level state when (i+1)th scan line is activated. The gate electrode of the pull-up transistor is electrically separated from the ith scan line. The above ‘m’ and ‘n’ are integers greater than 1 and ‘i’ is an integer no greater than ‘m’.

### BRIEF DESCRIPTION OF THE DRAWINGS

The above and other features and advantages of the present invention will become more apparent from a reading of the ensuing description together with the drawing, in which:

FIG. 1 is an equivalent circuit diagram illustrating a stage of a conventional shift register;

FIG. 2 is a front-view of a display panel driven by the conventional shift register when a breakdown is induced to one of stages of the conventional shift register;

FIG. 3 is a block diagram illustrating a shift register according to an example embodiment of the present invention;

FIG. 4 is an equivalent circuit diagram illustrating a stage of the shift register in FIG. 3;

FIG. 5 is an equivalent circuit diagram illustrating a pull-up driving section in FIG. 4;

FIG. 6 is a timing diagram showing an operation of the pull-up driving section in FIG. 5;

FIG. 7 is an equivalent circuit diagram illustrating a carriage section in FIG. 4;

FIG. 8 is an equivalent circuit diagram illustrating a pull-down driving section in FIG. 4;

FIG. 9 is a timing diagram showing an operation of the pull-down driving section in FIG. 8;

FIG. 10A is a graph illustrating an output of a stage having no riffle control section;

FIG. 10B is a graph illustrating an output of a stage having a riffle control section in FIG. 4;

FIG. 11 is a graph illustrating an output of a stage in FIG. 4 when a display panel has no defect such as an electric short at a pixel region;

FIG. 12 is a graph illustrating an output of a stage in FIG. 4 when a display panel has a defect such as an electric short at a pixel region;

FIG. 13 is an equivalent circuit diagram of a liquid crystal display panel; and

FIG. 14 is an equivalent circuit diagram of an organic light-emitting display.

### DESCRIPTION

In the drawing, the size and relative sizes of layers and regions may be exaggerated for clarity. It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

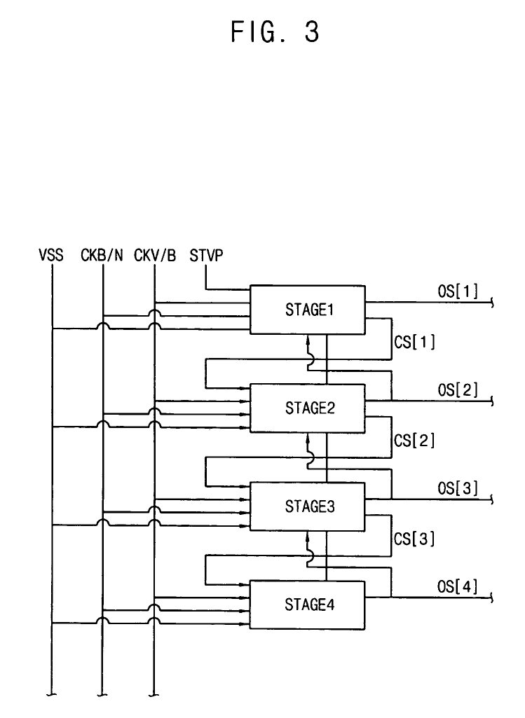

FIG. 3 is a block diagram illustrating a shift register according to an example embodiment of the present invention. Referring to FIG. 3, the shift register according to an example embodiment of the present invention includes a plurality of stages STAGE1, STAGE2, etc. A first clock signal CKV/B is applied to odd-numbered stages STAGE1, STAGE3, etc. to generate an output signal OS and a carrier signal CS. A second clock signal CKB/V is applied to even-numbered stages STAGE2, STAGE2, etc. to generate an output signal OS and a carrier signal CS. The first and second clock signals CKV/B and CKB/V have opposite phases to each other.

The first clock signal CKV/B is also applied to the even-numbered stages STAGE2, STAGE4, etc. to control a riffle control section of the odd-numbered stages STAGE1, STAGE3, etc. and the second clock signal CKB/V is also applied to the odd-numbered stages STAGE1, STAGE3, etc. to control a riffle control section of the even-numbered stages STAGE2, STAGE4, etc.

When a scan start signal STVP is applied to STAGE1, STAGE1 outputs an output signal OS[1] of a high level state and a carrier signal CS[1] of a high level state. The output signal OS[1] of a high level state is applied to a first scan line of a display panel (not shown) to activate the first scan line.

Carrier signal CS[1] output from STAGE1 is applied to STAGE2, so that STAGE2 outputs an output signal OS[2] of a high level state and a carrier signal CS[2] of a high level state. The output signal OS[2] of a high level state, which is output from STAGE2, is applied to STAGE1 to lower the output signal OS[1] to be in a low level state. The output signal OS[2] of a high level state, which is output from STAGE2, is also applied to a second scan line of the display panel (not shown) to activate the second scan line.

Carrier signal CS[2] output from STAGE2 is applied to STAGE3, so that STAGE3 outputs an output signal OS[3] of a high level state and a carrier signal CS[3] of a high level state. The output signal OS[3] of a high level state, which is output from STAGE3, is applied to STAGE2 to lower the output signal OS[2] to be in a low level state. The output signal OS[3] of a high level state, which is output from STAGE3, is also applied to a third scan line of the display panel (not shown) to activate the third scan line.

As described above, when the scan lines are sequentially activated, data voltages corresponding to pixels electrically connected to the activated scan lines are applied to cause the display panel to display an image. For convenience of drawing illustraion, the input terminal and the signal line of the last stage are not disclosed.

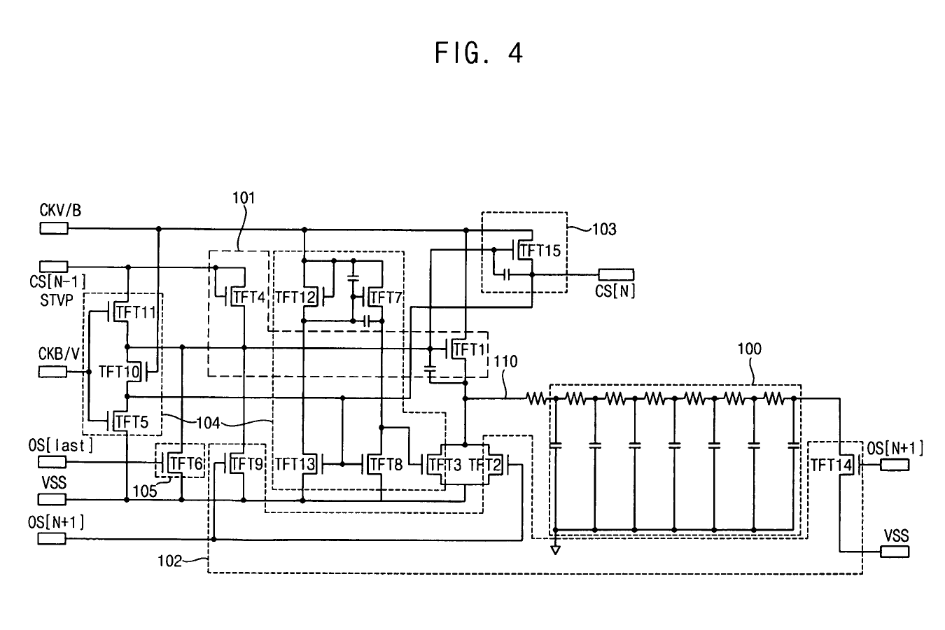

FIG. 4 is an equivalent circuit diagram illustrating a stage of the shift register in FIG. 3. Referring to FIG. 4, each STAGE1, STAGE2, etc. includes a pull-up driving section 101, a pull-down driving section 102, a carrier section 103, a riffle control section 104 and a frame-reset section 105.

The pull-up driving section 101 includes a pull-up transistor TFT1, and a transistor TFT4. Transistor TFT1 includes a source electrode that is electrically connected to a scan line 110, and a gate electrode that is electrically connected to the source electrode of transistor TFT4. The first clock signal CKV/B is applied to a drain electrode of transistor TFT1.

Transistor TFT4 includes gate and drain electrodes electrically connected to each other, so that transistor TFT4 operates as a diode. The source electrode of transistor TFT4 is electrically connected to the gate electrode of transistor TFT1. The scan start signal STVP or a carrier signal CS from a previous stage is applied to the drain and gate electrodes of transistor TFT4.

The pull-down driving section 102 includes a pull-down transistor TFT2, a transistor TFT9 and a transistor TFT14.

The output signal OS of a next stage is applied to the gate electrode of transistor TFT2, and a common voltage VSS of a low level is applied to a source electrode of transistor TFT2. The drain electrode of transistor TFT2 is electrically connected to scan line 110 of the display panel.

The output signal OS of the next stage is applied to a gate electrode of transistor TFT9, and the common voltage VSS of a low level is also applied to the source electrode of transistor TFT9. The drain electrode of transistor TFT9 is electrically connected to the gate electrode of t transistor TFT1.

The source electrode of transistor TFT14 is electrically connected to the common voltage VSS of a low level, and a drain electrode of transistor TFT14 is electrically connected to the scan line 110 of the display panel 100.

In detail, transistor TFT1 and transistor TFT2 are electrically connected to the first end of scan line 110, and transistor TFT14 is electrically connected to the second end of scan line 110. The gate electrode of transistor TFT14 receives an output signal OS from the next stage, as shown in FIG. 3.

Carrier section 103 includes a carrier transistor TFT15. The drain electrodes of transistors TFT15 and TFT1 are electrically connected together and the gate electrodes of transistors TFT1 and TFT15 are electrically connected together so that the carrier signal CS output from transistor TFT15 is substantially the same as the output signal OS output from transistor TFT1. The carrier signal CS output from TFT15 is applied to the gate electrode and the drain electrode of transistor TFT4 (not explicitly shown) of the next stage.

The riffle control section 104 includes a transistor TFT3, a transistor TFT5, a transistor TFT7, a transistor TFT8, a transistor TFT10, a transistor TFT11, a transistor TFT12 and a transistor TFT13.

The drain electrode and the source electrodes of transistor TFT3 are respectively connected to the drain electrode and the source electrodes of transistor TFT2. The gate electrode of transistor TFT3 is electrically connected to a drain electrode of transistor TFT8.

A second clock signal CKB/V is applied to the gate electrode of transistor TFT5, and a common voltage VSS of a low level is applied to the source electrode of transistor TFT5. The drain electrode of transistor TFT5 is electrically connected to the source electrode of transistor TFT15.

The first clock signal CKV/B is applied to the gate electrode and the drain electrode of the seventh transistor TFT7, and the source electrode of transistor TFT7 is electrically connected to the drain electrode of transistor TFT8 and to the gate electrode of transistor TFT3.

The common voltage VSS of a low level is applied to the source electrode of transistor TFT8. The gate electrode of transistor TFT8 is electrically connected to the gate electrode of transistor TFT13, the source electrode of the fifteenth transistor TFT15 and the drain electrode of transistor TFT5.

The first clock signal CKV/B is also applied to the gate electrode of transistor TFT10. The source electrode of transistor TFT10 is electrically connected to the drain electrode of transistor TFT5, the gate electrode of transistor TFT8, the gate electrode of transistor TFT13 and the source electrode of transistor TFT15.

The drain electrode of transistor TFT10 is electrically connected to the source electrode of transistor TFT11, the drain electrode of transistor TFT6, the drain electrode of transistor TFT9, the gate electrode of transistor TFT1 and the gate electrode of transistor TFT15.

The second clock signal CKB/V is also applied to a gate electrode of the transistor TFT11. The source electrode of transistor TFt11 is electrically connected to the drain electrode of transistor TFT10, the drain electrode of transistor TFT6, the drain electrode of transistor TFT9, the gate electrode of transistor TFT1 and the gate electrode of transistor TFT15.

The drain electrode of transistor TFT11 receives the scan start signal STVP or the carrier signal CS of the previous stage as shown in FIG. 3.

The scan start signal or the first clock signal CKV/B is also applied to the gate electrode of the twelfth transistor TFT12. The source electrode of transistor TFT12 is electrically connected to the drain electrode of transistor TFT13, the source electrode of transistor TFT7 and the drain electrode of transistor TFT8.

The drain electrode of transistor TFT13 is electrically connected to the source electrode of transistor TFT12, the source electrode of transistor TFT7 and the drain electrode of transistor TFT8. The gate electrode of transistor TFT13 is electrically connected to the gate electrode of transistor TFT8 and the source electrode of transistor TFT15.

The frame-reset section 105 includes a sixth transistor TFT6. The output signal OS[last] of the last stage is applied to the gate electrode of transistor TFT6. The drain electrode of transistor TFT6 is electrically connected to the source electrode of transistor TFT4 and the gate electrode of transistor TFT1. The common voltage VSS of a low level is also applied to the source electrode of transistor TFT6.

When the output signal OS[last] of the last stage is applied to the gate electrode of the sixth transistor TFT6, transistor TFT6 is turned on, so that the common voltage VSS of a low level is applied to the gate electrode of transistor TFT1. As a result, all stages are reset.

In the stages of the shift register according to the present invention, the gate electrodes of transistors TFT1 and TFT15 are electrically separated from scan line 110 of the display panel so as not to be influenced by an electric short of any transistor that is electrically connected to the scan line 110.

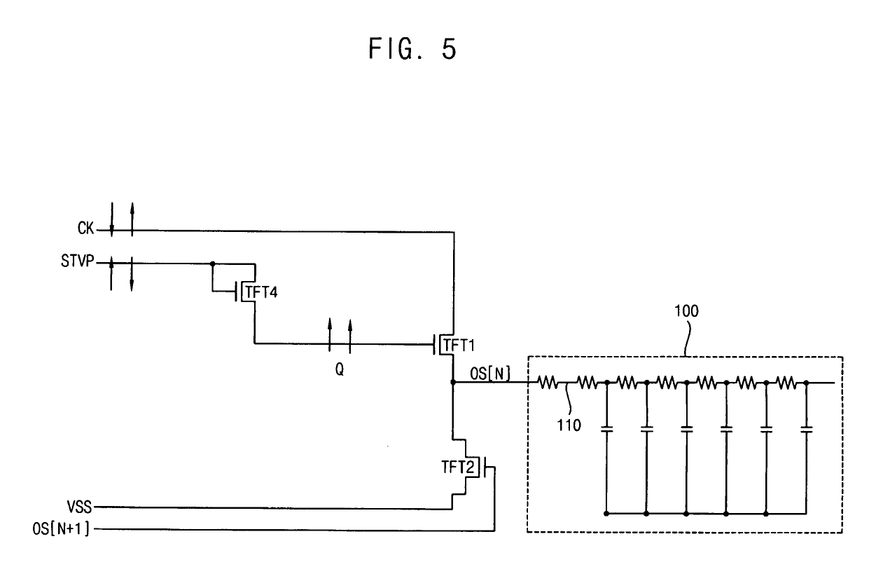

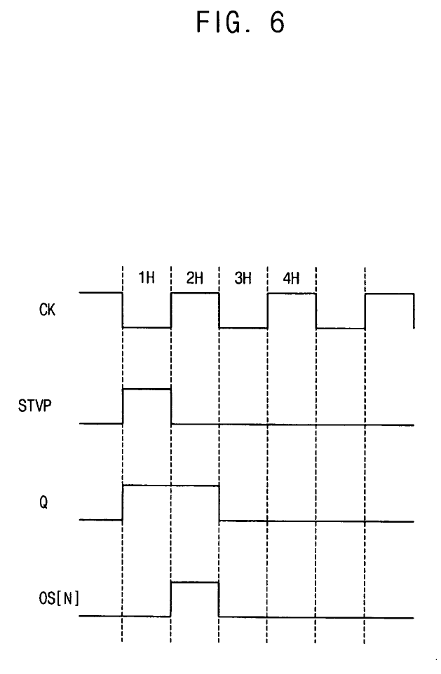

Hereinafter, the operation of each stage will be explained. FIG. 5 is an equivalent circuit diagram illustrating a pull-up driving section in FIG. 4 and FIG. 6 is a timing diagram showing an operation of the pull-up driving section in FIG. 5.

Referring to FIGS. 5 and 6, when the scan start signal STVP or a carrier signal CS (or output signal OS) of a previous stage, which is in a high state, is applied to the gate and drain electrodes of transistor TFT4 during 1H time period, transistor TFT4 is turned on, so that gate node ‘Q’ of transistor TFT1 is in a high level state. Then, when the scan start signal or a carrier signal CS of the previous stage, which is in a low state, is applied to the gate and drain electrodes of transistor TFT4 during 2H time period, transistor TFT4 is turned off. Therefore, the gate node ‘Q’ of the first transistor TFT1 remains in the high state. As a result, the first transistor TFT1 is turned on during the 1H and 2H time periods.

A clock signal corresponds to the first clock signal CKV/B when the stage corresponds to one of the odd-numbered stages STAGE1, STAGE3, etc. or the clock signal corresponds to the second clock signal CKB/V when the stage corresponds to one of the even-numbered stages STAGE2, STAGE4, etc. Here, the clock signal is applied to the drain electrode of the first transistor TFT1 that is turned on, so that the clock signal is output through the source electrode of the first transistor TFT1 to be applied to the scan line 110 of the display panel 100 as the output signal OS.

The clock signal has opposite phase to that of the scan start signal STVP or the carrier signal CS of the previous stage. Therefore, the output signal OS is in a low level state during the 1H time period and then, the output signal OS is in a high level state during the 2H time period.

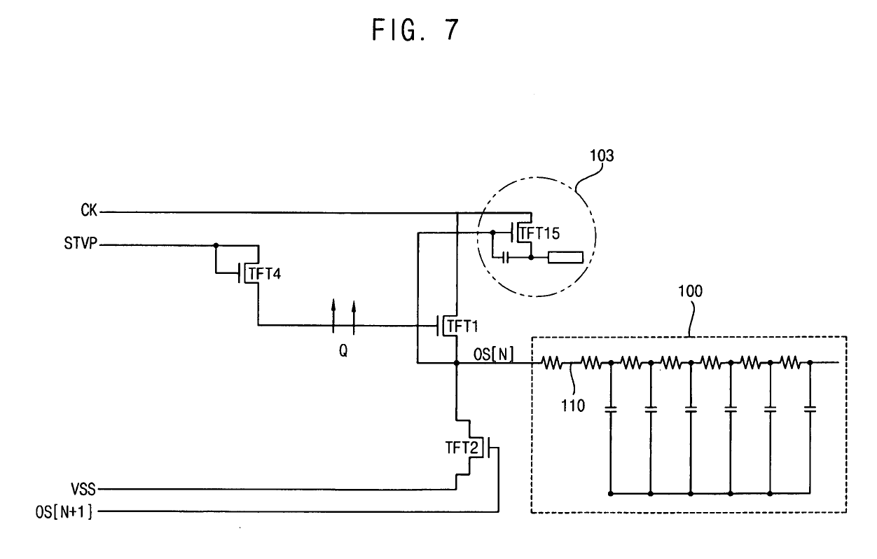

FIG. 7 is an equivalent circuit diagram illustrating a carrier section in FIG. 4.

Referring to FIG. 7, the drain electrode and the gate electrode of transistor TFT15 of the carrier section are respectively connected to the drain electrode and the gate electrode of transistor TFT1. Therefore, the carrier signal CS output from the source electrode of transistor TFT15 is substantially the same as that of the output signal OS output from the source electrode of transistor TFT1. As described above, when additional carrier section is formed, the load for operating the next stage applied to the first transistor TFT1 is lowered, thereby reducing the shading effect.

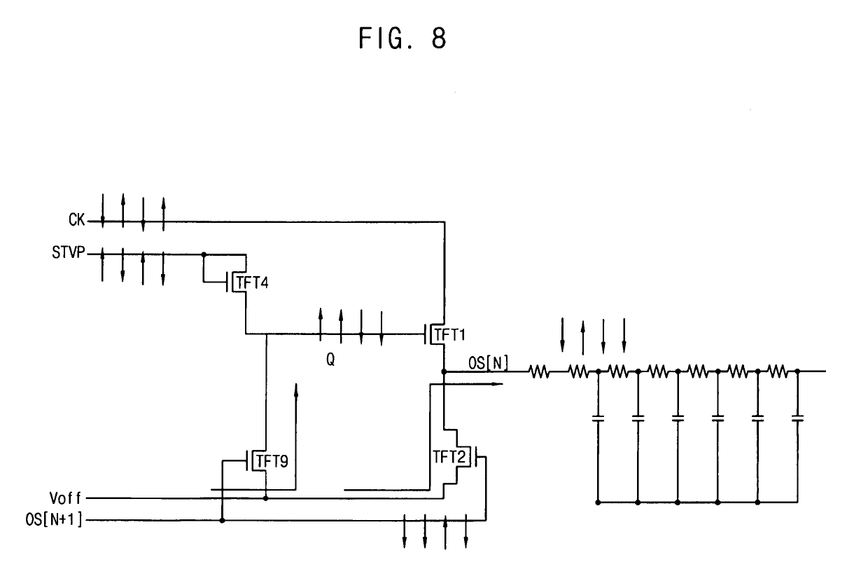

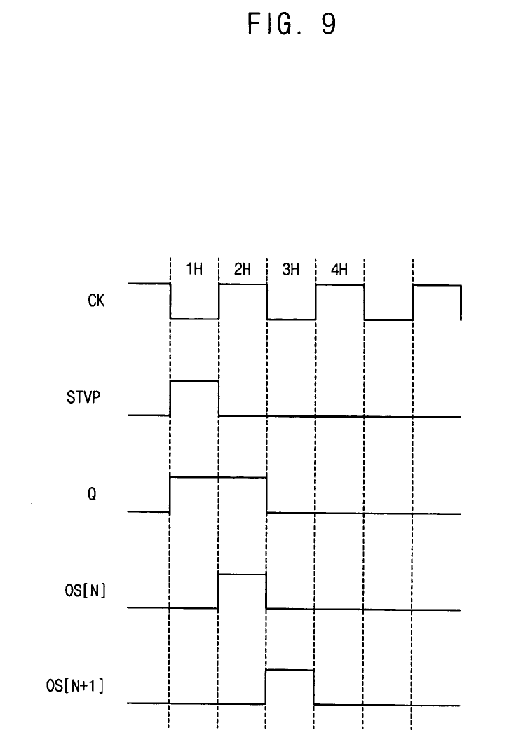

FIG. 8 is an equivalent circuit diagram illustrating the pull-down driving section of FIG. 4 while FIG. 9 is a timing diagram showing the operation of the pull-down driving section of FIG. 8.

Referring to FIGS. 8 and 9, when the carrier signal CS output during the time period 2H is applied to transistor TFT4 during the 2H time period, transistor TFT1 of the next stage outputs the output signal OS in a high level state during 3H time period. The output signal OS of a high level state, which is output from the first transistor TFT1, is applied to transistor TFT2 and transistor TFT9 of the present stage to turn on transistor TFT2 and transistor TFT9 of the present stage.

The turning on of TFT2 applies common voltage VSS of a low level to the scan line 100 of the display panel 100 and turning on of TFT9 applies the common voltage VSS of a low level to the gate electrode of transistor TFT1. Then, during the time period 4H, the output signal OS of the next stage becomes the common voltage of a low level, transistor TFT2 and transistor TFT9 of the present stage are turned off.

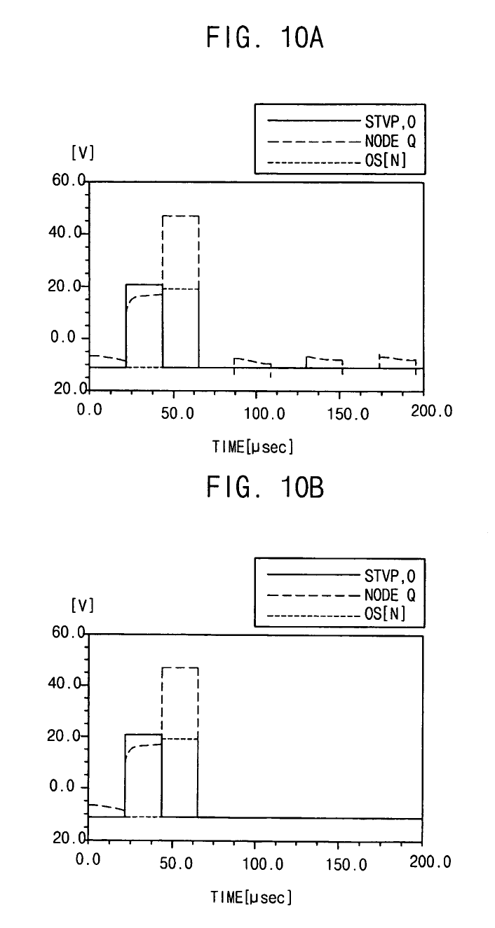

FIG. 10A is a graph illustrating an output of a stage having no riffle control section, and FIG. 10B is a graph illustrating an output of a stage having a riffle control section in FIG. 4.

When the stage in FIG. 4 does not include the riffle control section 104, the output signal OS and the carrier signal CS of each stage have riffles as shown in FIG. 10A. On the other hand, when the stage includes the riffle control section 104 as shown in FIG. 4, the riffles in FIG. 10A are eliminated as shown in FIG. 10B.

In order to drive the display panel, transistor TFT1 is larger than the other transistors. When the size of the first transistor TFT1 increases, the parasitic capacitance between the drain and gate electrodes of the first TFT1 accordingly increases.

When the parasitic capacitance between the drain and gate electrodes of the first TFT1 increases, the riffles also increase as shown FIG. 10A. However, the riffles of the output signal OS and the carrier signal CS are eliminated by riffle control section 104.

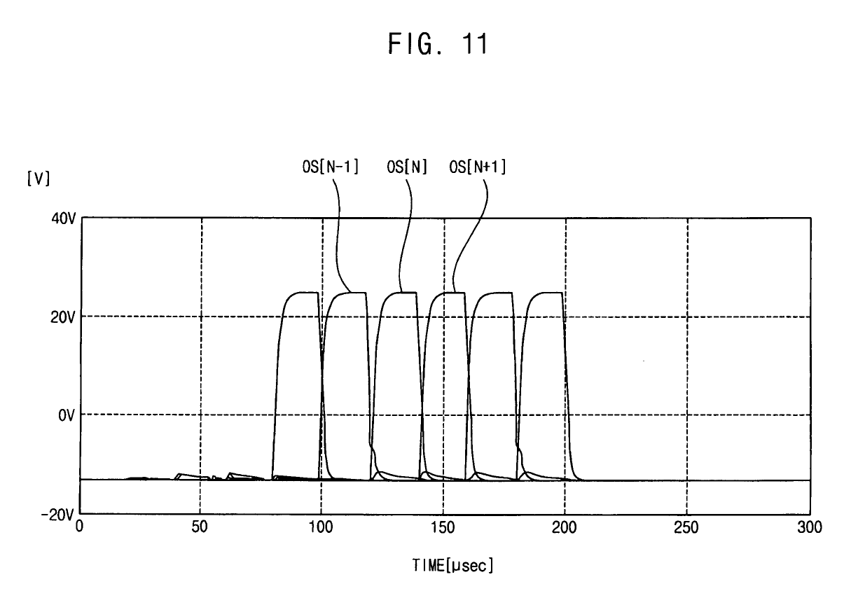

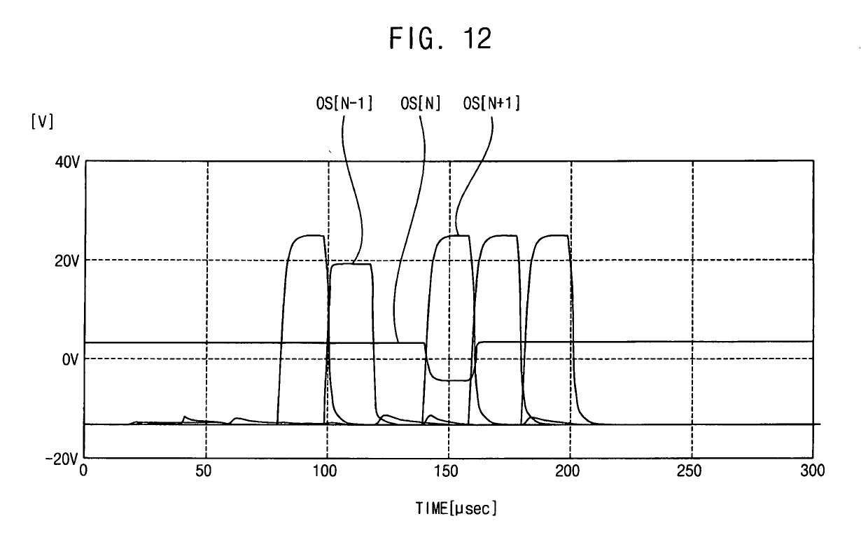

FIG. 11 is a graph illustrating the output of a stage in FIG. 4 when a display panel has no defect such as an electric short at a pixel region, and FIG. 12 is a graph illustrating an output of a stage in FIG. 4 when a display panel has a defect such as an electric short at a pixel region.

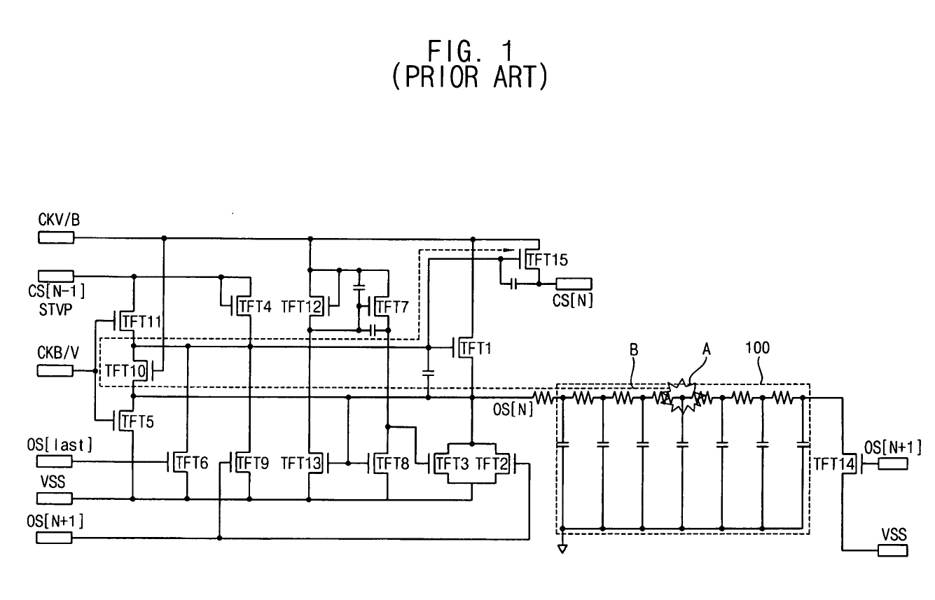

Referring to FIG. 11, when the pixels of the display apparatus normally operate, the shift register outputs substantially the same output signals as those of the conventional shift register including stages shown in FIG. 1.

The pixels of the display apparatus operate abnormally if the gate electrode of a transistor in the pixel area of the display apparatus is shorted to the common voltage, or if the gate electrode of the transistor is shorted to the drain electrode outputting the data voltage. Even when the pixels of the display apparatus operate abnormally, the stages other than the stages corresponding to the scan line electrically connected to the shorted gate electrode operate normally as shown in FIG. 12.

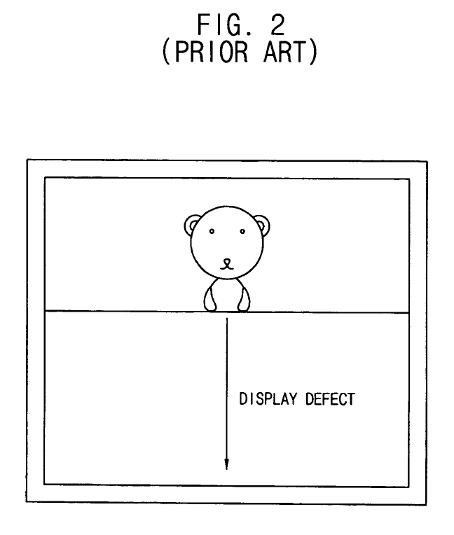

In detail, when a transistor of the pixel region electrically connected to an nth scan line is electrically shorted to the common voltage of about 3V, an nth output signal OS[n] drops to the common voltage, but an (n+1)th output signal OS[n+1] is normally output, thereby preventing the display defect shown in FIG. 2.

The shift register and the scan driver described above may be applied to various display panels such as a liquid crystal display (LCD) panel, an organic light-emitting display (OLED) panel, etc.

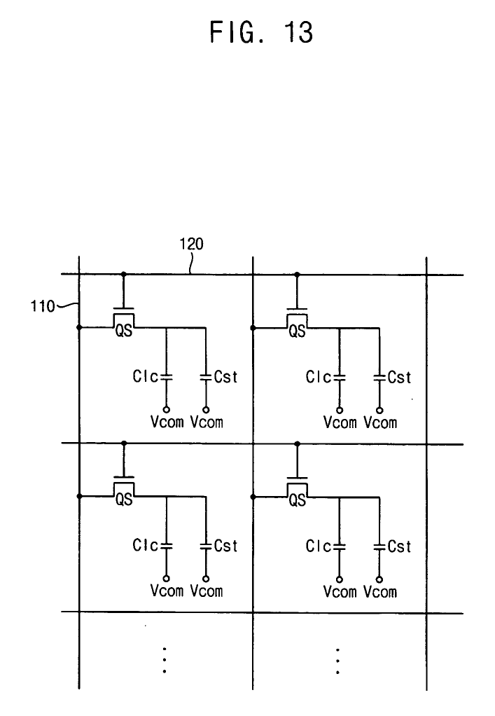

Hereinafter, the LCD panel and the OLED panel, which are representative of display panels, will be explained. FIG. 13 is an equivalent circuit diagram of a liquid crystal display panel.

The LCD panel includes a plurality of scan lines 120 and a plurality of data lines 110. The scan lines 120 extend along a first direction, and the data lines 110 extend along a second direction that is different from the first direction. Two adjacent scan lines 120 and two adjacent data lines 110 define a pixel.

The LCD panel further includes a plurality of switching transistors QS, a liquid crystal capacitors Clc and storage capacitors Cst. In detail, each of the pixels includes, for example, one switching transistor QS, one liquid crystal capacitor Clc and one storage capacitor Cst.

Each of the switching transistors QS includes a gate electrode that is electrically connected to one of the scan lines 120, a source electrode that is electrically connected to one of the data lines 110, and a drain electrode that is electrically connected to the liquid crystal capacitor Clc and the storage capacitor Cst. The liquid crystal capacitor Clc and the storage capacitor Cst are electrically connected to each other in parallel.

The liquid crystal capacitor Clc includes a pixel electrode (not shown), a common electrode (not shown) facing the pixel electrode, and liquid crystal layer disposed between the pixel electrode and the common electrode.

When an output signal OS output from one of the stages in FIG. 3 is applied to the scan line 120, the switching transistor QS that is electrically connected to the scan line 120 is turned on. When the switching transistor QS is turned on, a data voltage of the data line 110 is applied to the pixel electrode of the liquid crystal capacitor Clc. The storage capacitor Cst maintains the data voltage applied to the pixel electrode of the liquid crystal capacitor Clc for one frame.

When the data voltage is applied to the pixel electrode of the liquid crystal capacitor Clc, an electric field is generated between the pixel electrode and the common electrode to alter an arrangement of liquid crystal molecules of the liquid crystal layer disposed between the pixel electrode and the common electrode. When the arrangement of the liquid crystal molecules is altered, an optical transmittance is changed to display an image.

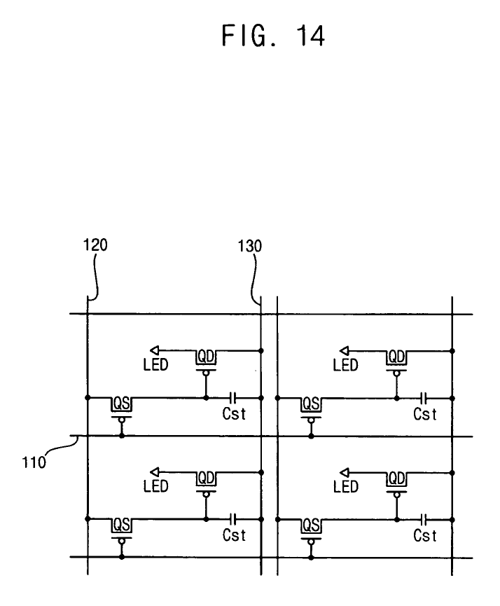

FIG. 14 is an equivalent circuit diagram of an organic light-emitting display. Referring to FIG. 14, an OLED panel includes a plurality of scan lines 110, a plurality of data lines 120, and a power source line 130. The scan lines 110 are extended along a first direction, and the data lines 120 are extended along a second direction that is different from the first direction. The power source line 130 is also extended along the first direction. Two adjacent scan lines 110 and two adjacent data lines 120 define a pixel.

The OLED panel further includes a switching transistor QS, a driving transistor QD, a storage capacitor Cst and a light emitting diode LED. Each pixel includes the switching transistor QS, the driving transistor QD, the storage capacitor Cst and the light emitting diode LED.

When an output signal OS output from one of the stages in FIG. 3 is applied to the scan line 110, the switching transistor QS that is electrically connected to the scan line 110 is turned on. When the switching transistor QS is turned on, a data voltage of the data line 120 is applied to the gate electrode of the driving transistor QD through the switching transistor QS. Therefore, an electric power of the power source line 130 is applied to the light emitting diode LED in accordance with an amount of the data voltage, so that the light emitting diode LED emits light. The OLED panel displays an image by controlling a light amount of each pixel.

Even when a switching transistor is a pixel region that is electrically shorted, the shift register and the scan driver according to the present invention normally activate scan lines next to a scan line that is electrically connected to the electrically shorted transistor.

Additionally, the shift register and the scan driver, according to the present invention, minimize the display defect and simplify detecting procedures to locate a cause of a breakdown.

That is, when output signals are output as shown in FIG. 12, if an electric short occurs in one of the switching transistors that are electrically connected to Nth scan line, the display apparatus may be repaired by repairing the switching transistor.

Having described the example embodiments of the present invention and its advantages, it is noted that various changes, substitutions and alterations can be made herein without departing from the spirit and scope of the invention.

What is claimed is:

1. A shift register, comprising:
an nth stage outputting an nth output signal; and
an (n+1)th stage that is electrically connected to the nth stage, the (n+1)th stage outputting an (n+1)th output signal that is normal even when the nth output signal is abnormal, wherein ‘n’ represents a natural number.

2. The shift register of claim 1, wherein the nth stage and the (n+1)th stage respectively comprise:
a pull-up driving section comprising a pull-up transistor that is electrically connected to an output terminal outputting the nth output signal and the (n+1)th output signal, respectively, the pull-up transistor raising the nth output signal and the (n+1)th output signal to be in a high level state; and
a pull-down driving section comprising a pull-down transistor that is electrically connected to the output terminal, the pull-down transistor lowering the nth output signal and the (n+1)th output signal to be in a low level state, and wherein a gate electrode of the pull-up transistor is electrically separated from the output terminal.

3. The shift register of claim 2, wherein the nth stage further comprises a carrier section comprising a carrier transistor that outputs carrier signal for driving the pull-up transistor of the (n+1)th stage, and gate and drain electrodes of the carrier transistor are electrically connected to gate and drain electrodes of the pull-up transistor of the nth stage, respectively.

4. The shift register of claim 2, wherein the nth stage and the (n+1)th stage comprise a riffle control section that reduces riffles of output signals output from the nth stage and the (n+1)th stage, respectively.

5. The shift register of claim 2, wherein the nth stage and the (n+1)th stage further comprise, respectively, a frame-reset section that resets a voltage of a gate electrode of the pull-up transistor to be in a low level state.

6. A scan driver that sequentially activates scan lines of a display apparatus having m-number of scan lines extended along a first direction, n-number of data lines extended along a second direction that is different from the first direction, and switching transistors, each of the switching transistors being formed in a pixel region defined by two adjacent scan lines and two adjacent data lines, comprising:
a pull-up driving section comprising a pull-up transistor that is electrically connected to an ith scan line to activate the ith scan line to be in a high level state; and
a pull-down driving section comprising a pull-down transistor that is electrically connected to the ith scan line to inactivate the ith scan line to be in a low level state when (i+1)th scan line is activated,
wherein a gate electrode of the pull-up transistor is electrically separated from the ith scan line, and wherein ‘m’ and ‘n’ are integers greater than 1, and ‘i’ is an integer no greater than ‘m’.

7. A display apparatus comprising:
a display panel comprising m-number of scan lines extended along a first direction, n-number of data lines extended along a second direction that is different from the first direction, and switching transistors, each of the switching transistors being formed in a pixel region defined by two adjacent scan lines and two adjacent data lines; and
a driving part that drives the display panel, the driving part comprising:
a pull-up driving section comprising a pull-up transistor that is electrically connected to an ith scan line to activate the ith scan line to be in a high level state; and
a pull-down driving section comprising a pull-down transistor that is electrically connected to the ith scan line to inactivate the ith scan line to be in a low level state when (i+1)th scan line is activated,
wherein a gate electrode of the pull-up transistor is electrically separated from the ith scan line, and wherein ‘m’ and ‘n’ are integers greater than 1, and ‘i’ is an integer no greater than ‘m’.

8. The display apparatus of claim 7, wherein the display panel corresponds to a liquid crystal display panel.

9. The display apparatus of claim 7, wherein the display panel corresponds to an organic light-emitting display panel.
